(19) United States
(12) Patent Application Publication
(10) Pub. No.: US 2017/0024668 A1
(43) Pub. Date: Jan. 26, 2017

(54) Automated Assessment and Solution Methodology

(71) Applicants: Charlene G. Aldridge, Dallas, TX (US); Scott Sterrantino, Frisco, TX (US)

(72) Inventors: Charlene G. Aldridge, Dallas, TX (US); Scott Sterrantino, Frisco, TX (US)

(21) Appl. No.: 14/807,341

(22) Filed: Jul. 23, 2015

(51) Int. Cl. G06Q 10/06; G09B 7/06

(52) U.S. Cl. CPC G06Q 10/0637; G09B 7/06

(57) ABSTRACT

Disclosed is an automated tool that assesses an organization's issues through assessments and determines the most appropriate solution flows based on the user's answers and question rank. This invention allows an organization to assess their issues and complete the solution flows in a fully automated environment, providing a less expensive, automated, self-paced flow to improve the organization versus the traditional in person consultation. Any discipline may be incorporated into the tool, allowing new information to be added any time and tailored to specific discipline needs.

### STATEMENT REGARDING FEDERAL SPONSORED R&D

None.

### CROSS REFERENCE TO RELATED APPLICATIONS

None.

### BACKGROUND OF THE INVENTION

1. Field of the Invention

The present invention relates to an automated tool that provides a pre-defined methodology and approach allowing the user to identify and solve issues. It is designed to be used in a variety of disciplines.

This invention provides the user with a structured approach to identifying issues by answers questions and obtaining a solution flow to resolve the issue.

The present invention is an automated computerized system that assesses issues in a variety of disciplines based on multiple choice quizzes (assessments) that then determines the most appropriate solution flows based on the user's answers and question rank.

2. Description of the Prior Art

Non-automated in-person consultation, whereas the assessment and resolution are determined by the consultant and administered to the client.

Non-automated in-person in-house expertise, whereas the assessment and resolution are determined by the in-house expert and administered in-house.

U.S. Pat No. 8,577,884 describes a method to provide automated analysis and summarization from free-form comments in a survey. This invention associates free-form comments with preprogrammed topics. This invention provides weights based on free-form wording rather than a scoring system based on specific pre-determined answers, and this invention simply reports the data. It does not create a flow based on the information provided.

U.S. Pat No. 7,027,994 describes a computerized knowledge brokerage system. This invention utilizes knowledge sharing over computer networks, allowing a form of networked consulting. This system appears to be more of a networking tool to establish connection between specific business groups and associated consultants. Our invention provides full automation utilizing response calculations based on pre-set questions.

### SUMMARY OF THE INVENTION

An important aspect of running any organization includes continuous evaluation and improvement of processes, policies, priorities, and methods to provide management oversight. Many organizations utilize outside consulting and/or highly specialized experts to help determine potential areas of improvement as well as the required steps to make those improvements. This level of consulting and expertise support may not be an option for some businesses and organizations, due to high consulting costs, time constraints, or ability to schedule meetings with the consulting firm and/or other resources.

This invention (automated assessment and solution methodology) allows for a less expensive, self-paced option that includes the user taking automated assessments that can be tailored for a variety of disciplines. Scoring and ranking from these assessments will automatically trigger the most important and appropriate solution flows, and the solution flow will take the user through steps needed to improve that particular item.

### BRIEF DESCRIPTION OF THE DRAWINGS

FIG. 1 is a flowchart of the assessment and solution flow of the automated tool according to the present invention.

### DETAILED DESCRIPTION OF THE INVENTION

### 1. Definitions

Assessments: a series of questions and corresponding optional answers that evaluates a pre-defined discipline through the selected answers

Automated tool: a mechanism or device designed to be used to perform the invention

Data dictionary: an index within the automated tool that provides the definitions of key terms or phrases

Disciplines: a word used to broadly describe a combination of industries, types of users, functional areas, and/or a subject

Functional areas: the departments, units, and/or divisions of an organization, i.e., Finance, Accounting, Information Technology, Operations, Sales, Marketing

Industries: a group of businesses that provide similar products and/or services

Questionnaires: a list of questions designed to identify specific information from the user, based on the answers selected

Scoring: the accumulative points based on the answers to the questions within a specific assessment

Solution: the series of steps to resolve an issue identified when taking the assessment

Solution flows: the methodology and approach defined based on the scoring and ranking upon completing an assessment

Subjects: a field of knowledge or practice

User type: the categorization of users based on numerous factors, i.e., industry

### 2. Best Mode of the Invention

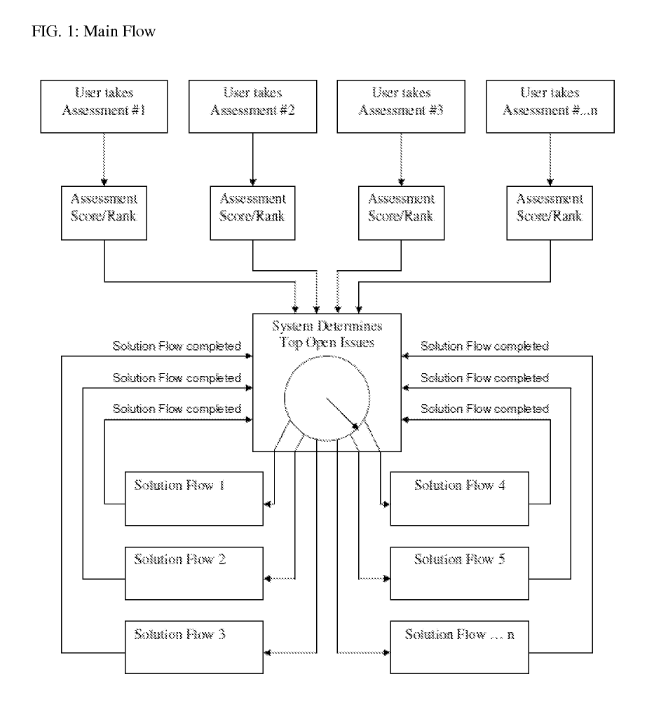

FIG. 1 provides a flow of the best mode contemplated by the inventors of the Automated Assessment and Solution Methodology.

### 3. How to Make the Invention

The assessment is created using pre-set multiple choice questions pertaining to the specific discipline or the assessment's topic. The particular questions, scoring for the potential answers, question ranking, and the specific issues for each question collectively will be determined and then stored in the system. Each assessment will be developed in the same manner utilizing specific expertise in the discipline pertaining to the given assessment.

The solution flow is developed utilizing experts in the given discipline. A standard step-by-step template will be developed, wherein each step will contain a specific component to complete the solution. Each step may include a data dictionary for definitions of terms and phrases, embedded instructions videos, helpful hints, and required tasks. The automated tool will ensure the current step is completed satisfactorily before enabling the next step. Much like an in-person consultant would assist any organization with required steps to solve particular issues; this automated tool will automatically walk a user through the steps with required input to meet a similar goal.

### 4. How to Use the Invention

It is a primary object of this invention to allow an organization to assess their issues and complete the solution flows in a fully automated environment, providing a less expensive, automated, self-paced flow to improve the organization versus the traditional in person consulting and/or in-house expertise.

This invention allows any discipline to be incorporated into the system, allowing disciplines to be added any time and tailored to specific needs.

This invention fulfills an untapped need by users who have limited resources to address their needs and/or do not want to engage external experts (i.e., in person consultants) or hire additional expert staff.

The user will have the ability to take multiple assessments based on a pre-defined order. Each assessment will consist of a series of questions and multiple choice answers. Each answer within the assessment will have a ranking in order to define where the user has the most improvement needs.

Each assessment will focus on a specific discipline which the user may have some opportunities for improvement. The accumulative selected answers will be scored and ranked to determine the greatest needs by the user for improvement in that specific discipline.

Throughout the use of the invention, the user will have the ability to continue at a self-pace including determining the frequency and timing of his/her work effort. Progress will be saved for future work.

As solutions are completed, the system will continue to use the assessment scoring to determine the next solution to activate. A limited number of solutions will be available at any given time to ensure the user has manageable solutions to work. To assist in managing the priorities, some solutions will require pre-requisite solutions to be completed before they are made available.

Solutions steps may utilize information provided on a previous step, as well as information provided in a completed solution. In this way, the solutions will build together to create a complete consulting solution for the organization.

All assessments and solution steps will be accessible, as well as any information stored within the solution steps, for future reference by the user. Assessments may be re-taken at a later time to determine improvement.

What is claimed is:

1. An automated tool comprising: multiple choice assessment questionnaires; multiple solution flows; and a mechanism to enable solution flows based on assessment completion.

2. An automated tool according to claim 1, wherein multiple questionnaires can be tailored for almost any discipline.

3. An automated tool according to claim 1, wherein each questionnaire contains multiple choice questions.

4. An automated tool according to claim 1, wherein multiple choice questions for each questionnaire have an internal scoring value per potential answer.

5. An automated tool according to claim 1, wherein scoring values for answered questions are summarized to determine and maintain score.

6. An automated tool according to claim 1, wherein individual questions within each questionnaire are ranked for importance within the questionnaire

7. An automated tool according to claim 1, wherein individual answer scoring value and ranking determine the top issues that need to be addressed.

8. An automated tool according to claim 1, wherein specific solution flows are enabled based on individual answer scoring and question ranking.

9. An automated tool according to claim 1, wherein assessment progress is recorded

10. An automated tool according to claim 1, wherein progress for each assessment and their totals are displayed.

11. An automated tool according to claim 1, wherein user is guided during each step of the assessment process.

12. An automated tool comprising: multiple choice assessment questionnaires; multiple solution flows; solution description to explain purpose of active task; solution instructions for each step in the flow; and supporting functions to walk user through solution process.

13. An automated tool according to claim 12, wherein solution flow contains step by step flow to address issues as determined in assessments.

14. An automated tool according to claim 12, wherein solutions are enabled by assessments' answer scoring and pre-requisite information per solution.

15. An automated tool according to claim 12, wherein each solution and its step by step instructions contain a list of pre-requisite solutions before being enabled.

16. An automated tool according to claim 12, wherein solution contains instruction for each step to guide user throughout the solution.

17. An automated tool according to claim 12, wherein each solution and its steps may include a data dictionary for definitions for terms and phrases, embedded instructions videos, helpful hints, and required tasks.

18. An automated tool according to claim 12, wherein the requirements for a solution step may be triggered by the specific information provided in the previous solution step.

19. An automated tool according to claim 12, wherein information is recorded for review of information for each completed step and each completed solution.

20. An automated tool according to claim 12, wherein the solutions' progress are displayed.
